(19) United States
(12) Patent Application Publication
(10) Pub. No.: US 2005/0279236 A1
(43) Pub. Date: Dec. 22, 2005

(54) Method of anti-counterfeit, printing, fabricating and the production of both security & non-security items including items that show the passing of time by sustained reaction

(76) Inventor: Mark Jennings, Southport (GB)

Correspondence Address: JOHN S. HALE;GIPPLE & HALE, 6665-A OLD DOMINION DRIVE, MCLEAN, VA, 22101, US

(21) Appl. No.: 10/870,043

(22) Filed: Jun. 18, 2004

(51) Int. Cl. B41F 33/00

(52) U.S. Cl. 101/483

(57) ABSTRACT

A method of printing on plastics like materials to produce anti-counterfeit or difficult to copy print for use in the security, food, packaging, advertising and labelling industries and the like. It also relates to a method of construction of items such as containers; documents; labels; cards, together with labels that display the age of a product and its sell by date. All processes described encompass around this invention, which can be, basically, a two piece Polyester/Polyethylene laminating process whereby the print and/or the hologram of the advertising label and the like is placed between the two films which are then sealed, heated, creased, fabricated, moulded without degradation to the print, which makes no contact whatsoever with any food-stuffs contained therein. With improvements in photocopying, documents, containers and labels are more easily reproduced. Thus the forging of trade marks on containers and documents is a major problem. The range of components being forged is vast. The production of labels, security cards, currency, tickets, bonds, shares and Membership cards are typical examples of the areas in which forging and copying is proving difficult to prevent.

This invention relates to printing, fabrication and filling of containers, particularly, though not exclusively, for the printing of plastics to produce containers and documents which are difficult to copy; it also relates to the construction of such containers and documents produced, there from including intermediate products made, and the methods of manufacturing, including producing square, rectangular or round containers, as well as filling and sealing of the finished containers. One machine that can be used, is able to carry out the printing; die cutting; creasing; bending; folding; moulding; fabrication; filling and sealing of the end product; thus giving a far superior hygienic packaging system than hitherto available.

With improvements in photocopying, documents and containers can be more easily re-produced. Thus the forging of trademarks on containers and documents is becoming a major problem. The range of components being forged is vast, like, labels, security cards, currency, tickets, deeds, bonds, shares and the like. Membership cards are just one, by way of example, of areas in which forging and copying is difficult to control.

Most paper documents wear quickly, there has thus been a desire to produce plastic documents of, for example, the type described. However to date, attempts to make plastic containers, labels and documents, which meet the needs of the producer or end user, have not proved satisfactory.

One major problem when printing onto plastics derives from the colorants used. Firstly, these colorants can be easily removed from plastics by the use of solvents, thereby leaving the documents open to counterfeiting. Attempts have been made in the past to bond a further plastics layer over the printed layer thereby enclosing the colorant. Two major problems arise. Firstly, it has been found that, for example, PVC or polyester/polyethylene film will not completely bond to itself or each other where one or the other has been colored with inks or dyes. It has also been found that printing directly onto plastics and then bonding a further plastic film thereto, encapsulating the colorants, proves unsatisfactory since these tend to run/bleed immediately or within a short period of time, resulting in an unreadable print. Whilst this problem can be diminished by drying the colorants with high-powered infrared or ultra-violet light, this process is time consuming, expensive and does nothing to improve lamination. Also all current security, credit/debit cards and the like have a solid background which makes photocopying and the like easy to do. It will be shown that most of the items produced using the following inventions are transparent or translucent.

One of the principal objects of this invention is to improve upon the quality of known products and to devise methods of so doing. The present invention is to be used to provide products which do not bleed or which bleed under controlled conditions.

In accordance with one aspect of the present invention, there is provided a process for printing a plastics film, comprising printing a colorant onto a layer of particulate or colloidal material, which material is releasably bound to a backing; enabling transference of colorant onto a plastics film by placing the first plastics film onto the printed layer, subjecting the plastics film and printed layer to a controlled heat process and removing the backing characterised by the designed particulate or colloidal sized materials.

Preferably the particulate or colloidal material should be inorganic although not always the criteria.

Preferably a second plastics film is bonded to the first plastics film, thereby encapsulating the colorant in the plastics.

When producing a document in this way, avoidance of bleeding of the inks can be achieved, if desired, and, furthermore, if a second layer of plastics is bonded to the printed plastics layer it bonds even where color has taken. By bonding a second layer thereto it becomes impossible to tamper with the first printed layer since the inks are enclosed within the plastics sandwich, forming an integral part of the plastics.

Preferably, the plastics film is a polyester film coated with polyethylene. Other plastics such as polyvinyl chloride may be used, but lamination is poor by security standards. However, the bonding properties of these plastics make it preferred as the ink, after bonding, is unaffected by acetone. Thus, where a food polyethylene coated polyester film is used, it is preferred that the colorants are transferred to the polyethylene coated surface.

A particulate or colloidal material is preferably silica based, or either sand, silicon, clay, chalk or ash or mixtures thereof. Silica based materials are the most preferred and is referred to throughout the remainder of this specification, although alternatives can be used when deemed advantageous.

Preferably the colloidal particles are laid or embedded onto a coating of latex (e.g. PVA) or starch or other form of adhesive although this is not always a prerequisite for success.

Preferably the backing is a dense paper, as the process demands, thus avoiding tearing whilst the paper is being removed, likewise other suitable backing materials can be used. Preferably, whatever backing is used there should be no loose fibres whenever possible, such as parchment paper.

The colorant or ink can be applied manually or by an automated process. The printing machine can be any of the currently used industrial standards, existing or perceived, including inkjet (digital printing) and micro-jet systems. However, when non-contact printing is used, such as inkjet, then the particulate coating must be of a sufficient thickness to absorb the ink.

The ink can be transferred to the plastic film by bringing the plastic film into contact with the particulate surface of the material, which material has been printed over, then subjecting it to a constant heat. This can be done by passing the layers through a standard laminator. The temperature required will depend on the plastics used and the sheet thickness.

The backing layer, usually a paper, can then be peeled away leaving a printed plastics sheet, which has absorbed the inks or colorants. Creating difficulty when attempting to remove the inks by solvents.

Alternatively, a plastics sheet can be coated with the particulate or colloidal material prior to printing. This can be done by the above-described method of heating the unprinted, coated paper and the plastics film then removing the paper or by directly coating the plastics in a coating machine. This allows the plastics film to be printed directly through a printing machine saving the cost and time needed to remove the backing paper. The results are the same in all printing machines except, that of the inkjet device. This is because there is not sufficient coating to absorb all of the ink and the ink can bleed. However, if the dots of ink fired from the ink head of an inkjet printer are of microdot size then less ink is released/sprayed and the coated plastics is heated at time of printing, then the micro-jet printing can be utilised.

A further embodiment of the patent is the fact that printed plastics can be bonded to a plurality of plastic materials encapsulating the colorants, ensuring the product is “tamper proof”. This is of particular importance for documents of a security nature.

According to another aspect of this invention, there is provided a printed plastics document manufactured or fabricated using the above specified process wherein two plastic films are laminated together encapsulating the colorant and the layer of particulate or colloidal material and the like.

Preferably the particle size of most or substantially all the particles is less than 5 microns to 0.006 μm (microns) in diameter, more preferably from 1 Um (micron) to 0.006 μm (Micron).

The particle size can be controlled by passing particles through a graded series of sieves thereby determining conclusively the requisite particle size best suited to the process being undertaken or contemplated.

The plastic film used may be formed from any of the plastics herein before disclosed and perceived in the future, but the current preferred plastics film is a polyester/polyethylene laminate.

Preferably the layer of particles is formed on the polyethylene side of the bi-laminate.

Improved printing quality derives from the colorant being transferred to the plastics from the particles in a “dry state”. If however the plastics are coated and then print is added to this coating then it matters not that the inks are wet, providing they are dried before laminating.

Different types of document can be produced by varying the silica content; by way of example, lower loadings will produce transparent documents, whereas higher loadings for opaque documents are possible.

In order to produce documents, which substantially do not bleed when the backing is removed, the layer of particulate or colloidal material should be exposed in a controlled atmosphere where humidity and time are paramount. In consequence thereof the second plastics film should be laminated to the first plastics film at a compatible temperature. This also applies to the silica, plastics layer and/or paper prior to being used for a product not intended to bleed.

In order to produce documents having printing which is initially legible but which later is intended to bleed, this said layer should preferably be exposed to an atmosphere determined by the process requirements. Therefore the first plastics film can be subjected to a very fine water mist. The second plastic film is then laminated to the first at a temperature consistent with the specification. Thus the layer takes in no further moisture from the controlled atmosphere. However, an easier and far more commercially viable way of producing a label that bleeds at a given rate has been invented.

Having printed onto the plastics, further additional steps can be taken to improve security, depending on the documents specified use.

Laminated documents, for example, money, tickets etc. a security mark similar to that known as a “water-mark” can be applied. This mark hereafter referred to as an “opticmark”, may be produced by the following method.

The best results come from heavier paper having applied thereon fine particles of silica, has a design embossed upon it using a metal die or other means. The preferred side for the impression is the non-coated side, which is depressed, the coated side being raised. It will work the other way around, but less effectively. The embossed sheet is then placed particle side down onto the polyethylene side of the plastics film and passed through a laminating process as already described with reference to the transfer of inks from the coated sheet. After which the backing paper is removed and then a second plastic film is laminated to the first film. The resultant mark is visible, but contains no inks. If the finished document is touched with the fingers, no apparent raising of the plastics is felt.

There now follows a description of a particular embodiment of the invention by way of example only.

In producing a printed plastics document, which also comprises an “opticmark”, the following procedure is preferred.

A sheet comprising, preferably, a parchment paper backing having thereon a layer of silica, upon which the design is printed on the silica. Standard printing inks or dyes being used, the design is applied by a computer-controlled printer, printing plate or other acceptable methods of image transfer technology.

At a selected area of the sheet, preferably where no printing has already taken place, the coated paper surface is raised or lowered by an embossing process with the selected design forming the “Opticmark”.

The printed sheet is then covered, by way of example, with a polyester plastics sheet with a thick polyethylene coat on at least one side, ensuring that the polyethylene coat overlays the silica coated surface of the printed sheet. The two are heated to a temperature at which the polyethylene melts/softens sufficiently to take up both ink and coating. The heating cycle should be constant throughout, together with sufficient pressure ensuring any air between the sheets is completely expelled.

The backing paper is then removed.

Where there is embossing, the raised area of the paper allows more silica to come into contact with the polyethylene and subsequently, over-loads the polyethylene with silica. Pressure exacted, causes the polyethylene to be moved to either side of the over-loaded area. When another plastics sheet is brought into contact with the sheet and laminated, the paper having been removed, a distinctive image appears. The amount of heat used in lamination can affect the clarity of the mark. The hotter the lamination the less clear the resulting embossed mark. This is because, heat breaks down the coating to become invisible and if the coating is completely broken down, it allows the melted polyethylene to go back to its original position, obliterating the original image.

Generally a controlled lamination temperature is used. However this is not a limiting factor as it has been found that larger particles of silica require higher temperatures, and smaller particles, lower temperatures.

A further embodiment of this present invention is a method of producing chemically assembled dies or moulds from which patterned surfaces can be fabricated for the containment of ink, colorants and the like in the form of bar codes and similar machine readable codes enabling bleeds to take place to show the elapsed time of the product in the container to which these micro sized coded devises will be attached. The techniques is such that it can produce features as small as 100 nm and perhaps even smaller with further development, where only machine reading of these codes and “watermarks”/“opticmarks” would be possible i.e. invisible to the naked eye, therefore not copyable or reproducible using hazing techniques.

Where laminations are used to encapsulate the colorants it is possible, to incorporate other security devices between the sheets to be laminated. By way of example, signature strips, passive electronic chips, holograms, as well as biometric devices being incorporated into the final product.

The present invention can be designed to produce documents with infinitely variable bleed times ranging from seconds to years.

By way of a still further example of this invention, were using paper and diethylene glycol ink comprising a food dye can be used in a similar fashion. The ink is prepared by treating an off-the-shelf food dye in such a way that the remaining liquid is then mixed with diethylene glycol (digol). The paper is loaded with an even layer of silica at a specific particle size and then printed by way of example only, with the ink using an inkjet printer. The printed layer is then placed against a polyester/polyethylene plastics film and heated at a temperature sufficient to transfer the printed layer to the polyethylene layer and the paper is then removed. The resultant product is then left at the humidity level and exposure time required before the second lamination takes place at a controlled temperature.

The length of time taken for the ink used to bleed (i.e. for the printing to become blurred to the naked eye) is determined by regular inspections.

Bleeding could be effected with other inkjet inks provided that after removing the backing paper the layer of silica is exposed to a controlled atmosphere and humidity and that the temperature at final lamination is within the specified limits.

It is important in certain circumstances that bleeding occurs after an elapsed time. This is the case, for example, where a ticket or card is intended to be valid for a limited period only, the expiry of the said period being indicated by bleeding of the ink. By regulating the humidity, temperature and ink used, the time can be varied as to when bleeding occurs.

By appropriate variation of these parameters, cards can be produced which will bleed after several minutes or years.

However, puncturing or tearing the card to expose the silica to the atmosphere can accelerate bleeding. One such application of this method is where the consumer products require such labelling. The label can be formed with a line or point of weakness to which it is attached via a tag, to the consumer product or container. When the label is removed from the tag, tearing along the line of weakness exposes the silica thereby accelerating bleeding.

If these labels are somehow reattached, say for instance, to clothing, bleeding will still occur. This has obvious advantages in avoiding fraud by indicating attempted security evasion to shop and security staff once a label has been removed from the product.

In the case of clothing, this label after being pierced, will then attract moisture from the body. If the label shows signs of slight bleeding where it was pierced, this will show the garment has just been “tried on”. If the article is worn for more than 2 hours, the whole of the label will have bled. However, the ink does not escape from the label. A further refinement of this technique is for the tag of the label to be attached to the consumer products via adhesives that coats a removable holographic image on the tag. Thus, if an attempt has been made to remove the label by pulling at the tag and avoiding the line at the point of weakness, the label and tag can be removed together, but this destroys the holographic image. A label comprising the removable holographic image and adhesive is also within the scope of this present invention.

As mentioned elsewhere in the text, improvements can be made to the above described “bleed label” in a number of ways. It is possible to incorporate a destruct date at the time of manufacture but for commercial reasons, namely because run times cannot be guaranteed by the printer, and most end users will want to order the labels in advance of requirements, storing same for later use. Therefore, this invention is able to overcome such problems as herein described. A more recent innovation which forms part of this invention is to use the above described ink, manufactured from food dyes, or any other dye or pigment that is non-permanent and to print this ink on to a very heavily loaded silica coated sheet of paper, or the like, where by this print is transferred to a plastics sheet as described above which is not taken into the polyethylene.

A further embodiment for transferring the silica to the plastics sheet has been developed, whereby, paper is not required as a medium. This is achievable as described in two following embodiments.

The first is a method where a low viscosity, non-permanent ink, which can be colored or clear, is mixed with silica to a determined consistency then laid down by a printing machine, directly to the plastic sheet then allowed to dry.

A second method has been developed whereby an adhesive is applied to the plastic sheet and a coating of silica is sprayed, preferably, but not necessarily, in a dry state, to the said adhesive. This plastic sheet is then printed, whereby the silica or as well as, the plastics sheet is over printed.

This resultant, printed sheet is able to display the age of a product. To explain this innovation, by way of examples, the following examples describe a number of methods of producing this unique innovative label technology.

The first example describes how print is applied to the coated paper; it can also however be printed onto an already coated plastics sheet as previously described.

To produce a label that will display the age of a product, for example, milk, over a seven days period, the following procedure can be adapted for this purpose.

By way of example only, each day (24 hour period) or part thereof will be represented by a circle with a number at its centre. Within this area there are 8 circles or combinations thereof, in total using a fixed diameter. Each circle touches the circumference of the adjacent circle and each circle is in a straight line. The outer ring of the circle is, for instance, red, the inner is yellow or another suitable color. In the centre of the yellow area is a number. The numbers range from 1-7 the eighth circle is marked as “start” and precedes the number “7” circle. This is because the numbers are in a descending order—showing the numbers of days left before the sell-by-date is reached where by the product is still usable.

This printed area is then placed on the polyethylene side of the laminate as described in this invention, except that this time the polyethylene or a similar material has a low-melt specification. At the design temperature, the coated paper, print, or silica laid down in an alternative way to that previously described, is then passed through the laminator. The paper is removed and the plastic sheet is then offered up to a second plastic sheet, which has a hole in it. This hole is aligned with the printed area that has “start” printed in the centre of the first circle. The two plastics sheets are then subjected to the specified heating phase. This bonds the two plastics together around the print but does not bond the sheets together in the printed silica area. However, it must be noted that this is not a limiting factor, we have found during research that the silica, can indeed, in some cases, be bonded to the plastic.

By way of a further embodiment, on the back of this label is adhered an absorbent strip of paper being the length and breadth of the printed area. The end of this paper, fits over the hole in the plastic sheet, including the back of the label. To this paper is added a liquid which can be food compatible. However, the higher the viscosity of this liquid, the slower the reaction. For this example the liquid used has a similar viscosity to that of vegetable oil. To this saturated paper is adhered a third layer of plastic which is wider than the paper, thereby creating a seal preventing the liquid from evaporating or contaminating anything to which it may make contact with. The “label” now has a sealed environment. By using these parameters, the rate at which the liquid travels through one of the printed circles is twenty four hours or other time specific periods. Because of the design of the ink, it bleeds and runs at the same speed as the liquid, thus showing instantly the elapsed time of the label.

This label can be produced larger during manufacture to cope with extended periods of time prior to being placed on the product. Alternatively, the moisture for the label can be withheld until the time it is required for the product. If the silica part of the label is subjected to higher temperatures, then the rate of “bleed” is slowed down—consequently the same sized label, containing the same liquid can be used for showing various time specific periods (i.e. 7 days/7 weeks/7 months etc.). This is because the higher the temperature, the softer the Polyethylene becomes, consequently, more silica embeds within the plastic reducing the path, thereby reducing the flow rate of the liquid through the conduit.

A second and easier method of producing this label is to proceed with the above up to the point where the paper or other substances act like a wick is adhered to the back of the label. The resultant label is then offered up to the packaging that has a small hole placed within it. This hole allows the contents to pass through when filled. The label is placed in such away that the end of the label with the hole is placed at the furthest point away from the hole in the carton. Which means that the end of the paper (wick) makes contact with the hole in the carton. This label is produced so that an airtight seal is made around the hole in the carton, thus preventing leakage of contents or ingress of air/bacteria entering the carton. When the carton is formed later and filled, the contents work their way along the wick for the entire length of the label until it reaches the hole within the label at the opposite end. By adjusting the size of the aperture, the shape of the laid down silica and the width of the “wick”, the rate of bleed can be predetermined. It has been developed so that the inks and silica used cannot leach back from the label into the product, thereby avoiding contamination of the contents. Likewise it has been designed so that pressure on the carton does not effect the rate of bleed. Instead of using the conduit, as mentioned with both the carton and the label, a point of weakness can be designed, so that when sufficient pressure in one form or another, including bending, is brought to bear at the point of weakness, a fracture appears, allowing the liquid to flow.

By way of example, a further embodiment for producing the same effect is described by a rectangular area on a sheet of plastic is “marked out” with a dividing line through the middle so that there are now two equal areas. On one of these areas contains a liquid, which can be “loose” or held by an absorbent sheet as described elsewhere or within hollow glass beads. The other area is a printed silica. This silica can be laid down as described elsewhere or it can be mixed with the inks so that the silica is laid down at the time of printing.

A prepared plastic sheet is placed above another plastic sheet, which can be either laminated by pressure bonding or glued to the first plastic sheet. This second sheet contains two holes. Each of these holes is in the same relative position to one another. I.e. one is over the liquid and the other is over the silica. Over these two sheets is a lightly adhered third plastic sheet, the purpose of which is to prevent contamination or evaporation of the liquid or the silica. However, the adhesive used should be aggressive enough to positively bond the two previously mentioned sheets together so that no ingress of any contaminates occurs from outside or inside influences, such as the liquid draining away. During use, the third plastic sheet is removed and the remaining two plastic sheets are folded to form a square or rectangle or any other desired shape. On folding, the two holes line up thus allowing the timing process to begin. Where glass beads are used to contain the liquid, pressure needs to be exerted so as to break the beads and release the liquid.

By way of a further embodiment, first the plastic sheet is divided into “compartments” using adhesive or other bonding methods. These compartments are formed by the way in which the adhesives are laid down, but for this example the pattern that is laid down is in the shape of a bottle, the neck of which is at the top of the label. Within this bottle shape is the liquid. This first plastic sheet is then covered by a second plastic sheet which has the effect of trapping the liquid, which again can be loose or as described previously. On either or one side of the plastic sheets a “V” shaped cut is placed in line with the top half of the neck of the bottle. To one side of these sheets is an aggressively adhered plastics sheet, which contains the printed silica (The adhesive does not touch the silica). This is adhered as far as the bottle neck. To the other side of the bottle being adhered to a forth plastic sheet, which again is obdurately adhered as far as the bottle neck. Above the bottle neck is an adhesive that will allow the top and bottom most sheets to be pulled back when in use. When required, the said sheets are pulled back by the user and the innermost sheets are torn, by the user, from the “V” shape along a straight path across the bottle neck; the torn off piece is discarded. The two outer most sheets are then pressed together to form a seal. This then allows the liquid to issue from the bottleneck thus starting the timing process as the silica absorbs it.

In a further embodiment, two separate parts can be made to the label. On one part is the printed silica and on the other is the wick part. Each part being made as described elsewhere within this text. The two parts are kept apart, by way of example, by being made into two separate rolls. Each of these rolls is set up so that they are unrolled and brought together, mechanically or by hand, and adhered to each other. At the time they are brought together the bleed process begins. These labels can then be immediately adhered to whichever product they are designed to be adhered to.

In a further embodiment, any of the described inventions and processes can be placed within other printed materials. By way of example, the bleed label can be incorporated within another label that has already been printed, possibly elsewhere, so that the two parts of the label become as one unit.

In a still further embodiment, a reservoir for the liquid can be achieved by the use of MEMS, which can include holograms and microdot sized, and nanodot sized code bearing security dots.

In still a further embodiment, it has been found that if a substance such as baking powder, by way of example only, is placed as a small dot underneath or above the printed silica, prior to lamination, when the moisture or solvent reaches it, the baking powder reacts, releasing gas. This gas pushes the plastic to form a small bubble. The point of this small bubble is so that a blind person, on running his/her finger along the label can determine the rate of bleed of said label.

In still a further embodiment, raised parts of the label can be made by mechanical means so that the blind can also determine other information within the label.

Other uses for this type of innovation are infinitely variable, such as calendars whereby each day is wiped out as the bleed progresses. In this case, a liquid that has a bleaching effect could be used. To achieve this effect over 365 days, would be to increase the reservoir of fluid as described above in all examples, but the “entrance” to the printed area would remain the same so as to establish the same rate of flow.

The same procedure with the “timed bleed” could be used in a variety of ways—but not as dates. By way of example, a printed picture could be used, which degrades over a given time or, alternatively, over a period of time, using the bleed technology, it could produce a picture like painting by numbers—whereby the liquid is clear until it comes into contact with hidden color within the picture.

Alternatively, a jigsaw can be made which is clear until the last piece is laid. When complete, the bleed reaction starts, revealing a picture. Security cards could be made that could be stored and used on a “one day lifetime” basis. The bleed being triggered by pressure of the issuing person or by simply dipping it in a liquid, or swiping it across a wet sponge or by any of the above mentioned examples. All of these can incorporate holograms or printed patterns/pictures/colors at the back so that as the ink clears, the backing shows through, displaying another means of instant alert.

In another embodiment, warning signs can be produced. This is achieved by printing the warning on one side of a plastic sheet and then laying down silica on the other side of the plastic sheet, to a thickness that will cover the warning so that it cannot be read when viewed silica side on. When the silica absorbs enough moisture from the atmosphere or from any other source, the silica will become partially transparent, thus allowing the message to show through. The silica can then be dried and return to its original form to be used again.

Another way of creating a colorant bleed, is to use Magneto-strictive material (known as GMM) and produced from rare earth elements; Terbium, Samarium and Dysprosium. It is an isotropic and volume conserving material. If placed in the channel between the encapsulated colorant reservoir and the delivery canal or conduit. Depending upon requirements, it can act as a shut off valve or is powerful enough to fracture the plastic weld, when subjected to electromagnetic energy, allowing bleed into the colorant delivery canal.

With regards to the clear printed plastic described earlier in this specification, it has also been proven that if a de-metallized hologram is printed on polyester and then placed, for example, in the centre of a number of various other sheets of printed laminate, then the special effects can be produced which to date are uncopyable by known or perceived copying technology

It has been proven that anything printed above the hologram, which in itself is transparent, when tilted towards the light, appears as though embedded within the hologram. Also, any part of the top-most layer, if tilted is all that can be viewed of the image, so that in the case of a credit card, the upper most area should be printed with the name, signature and account number of the authorised holder, if security is required, preventing these details being copied.

In a further embodiment a hybrid document can be produced i.e. one embodying the printed plastic described with an insert of printed-paper or other materials that can be marked when pressure is applied there to. Since the printed material used will eventually fade, it is preferred in some embodiments to coat the plastic with a material that reflects ultra-violet light or to use an ultra-violet resistant polyester, in which this light is responsible for the fading.

A still further embodiment, where the fading of the ink is due to exposure to either UV or IR light which can be used advantageously to fight crime. For example, tickets such as concert or football tickets may have certain information printed thereon using an ink which on exposure to a high intensity of ultra-violet light will degrade, exposing attempted fraud.

The following additional features are included:

For instance only one part of an image or pattern is applied to a document. The person receiving the tickets at the entrance to the establishment holds the other part of the pattern. That person can then quickly place the transparent ticket over the template he holds and if the pattern/image is complete, then that ticket is “passed”. Fingerprints, the iris, DNA and many other bio-metric features can be applied, because of the transparent nature of the document this can be placed over a recorded bio-metric image or data storage system for verification. With fingerprints, because the document is transparent, the printed image of the fingerprint can be placed over a specimen fingerprint, made by the holder of the document, onto say, a sheet of paper, and quickly verified. A magnifying glass or a machine capable of verifying the prints are the same or similar would obviously be advantageous.

In a further embodiment, a heat sensitive material or environmentally friendly chemical can be used, by way of example, on a ticket so that a pre-defined number/pattern or image shows up when heat is applied.

In a further embodiment, items such as compact Disks (CD's) and Digital Video Disks, sometimes known as, Digital Versatile Disks (DVD's), can be exposed quickly as genuine or a forgery. Customs and Excise and Police do not have the time or are unable to carry special equipment to show up forgeries of CD's and DVD's. They need a quick method of verification. This invention, by way of example, describes how this is achieved.

The box in which CD's or DVD's are packed is normally referred to as “the jewel Box”. This jewel Box can be used to show up counterfeits using a number of ways described herein by way of example, two methods are defined. A transparent print produced as described elsewhere within this application is produced in such a way so that the front print contains half of a graphic print and the rear contains the other half. In between these prints is a transparent or translucent hologram as previously described. This print describes the contents replacing the normal paper print used at the front of the jewel box. Behind this document is a black or dark colored, preferably, but not necessarily, sheet of paper. A tag, connected to this sheet of paper, lies outside the jewel case. When this tag is pulled, it removes the paper and the whole of the graphic print shows up. Thus instantly revealing a genuine or bogus print.

In a further example, a small hinged print, made in a similar manner as described elsewhere regarding a credit type card application, which enables it to be adhered to the outside of the jewel case in such a manner that it can be raised to inspect both sides.

Another embodiment uses fibre-optics incorporated into a document. They can be applied so that one or more fibres which have been etched using laser technology or similar means using alpha numeric codes or images, which are affixed on or between the laminate sheets so that when a light is applied to the edge of the card, when viewed from the front of the card these codes, characters or images show up clearly. It has also been proven beyond doubt that if the amount of light is measured at the start of the fibres, the amount of light received at the other end will depend on the amount and size of the codes, characters, images etched onto the fibres, due to the light leaking, diverted or by refraction or reflection through the security codes. Therefore the amount of light received at the other end can be anticipated and measured if it does not reach the designed standards either higher or lower levels, then, the card/document is assumed to have been tampered with or is a forgery.

A still further embodiment, whereby a number of fibres designed in such a way, that light transmission through to the other edge of the card, which when it arrives at that edge, the read point sensors will detect the received light. If the correct codes are not received then the card is deemed to be a forgery.

Another embodiment of this invention is that fibres can be arranged in such a way that they are read as an alpha/numeric code using the same principle as bar-codes and the likes. Each card having its own unique numbers or bar-code. A further embodiment, whereby fluorescent fibres can be used, enabling light to be transmitted via the surface of the fibre to the fibre ends. These likewise can be etched and read by suitable sensors either visual, manually or automatic machine readable devices.

If in the case of a credit card, by way of example, fibre optics are placed across the whole of the card where information such as encrypted account details, name, etc., plus any other information, can be etched in and read by automatic readers by moving the card relative to the reader. All the above embodiments can be used in a computer where light/laser beams are used in conjunction with fibre optic devices operating at the speed of light, replacing slower electrical methods for the transmission and storage of data and the like.

All the aforementioned embodiments offer a wealth of untamperable information which can be held within the passive card making the magnetic obsolete. However, magnetic strips can be fixed/sprayed onto or into a product of the present invention, if the end user prefers to remain a user of these out of date technology devices.

Generally, a person reads transparent documents against a plain background. If by way of example, the document is placed against, a white background the details of the document will show up clearly.

For documents that may be used where no suitable background exists, a plain hinged back/page can be affixed during manufacture.

When inspecting the card one can see the card clearly, by turning over the back/page, will see immediately that no changes or insertions have been attempted.

Alternatively, a de-metallized hologram, the same size in area of the surface of the document/card can be included in the centre of the security device so that any different print shows on either side of this; the ultimate security device. If a de-metallized hologram is used, the card appears to be transparent when held up to the light or viewed over a light/white background. This causes both sides of this security device to be seen at the same time, making it unreadable. However, if it is placed in the hand or over a dark background, the rear most print becomes invisible and only the front image can be seen by the naked eye. Should attempts to photocopy or scan by whatever means both sides of the card will show up on the forged print rendering attempted forgeries useless. In some circumstances holograms themselves make a photocopy appear black as it reflects most if not all the light.

Using herein above described methods, it has also been proven that a unique security label can be produced with certain properties that are described below.

Techniques for metallization and de-metallization are known. But the best thickness of metallisation for the purposes of this invention is dependant upon the specification for which the metallization is being designed. This metallized plastic is one which produces an Optical Haze of between 1.8 and 1.9 reading. This density produces the best optical characteristics enhancing this invention but other hazes could be used, dependant upon the security required for the end product.

To avoid complicating the description of this invention where metallization is mentioned in the text, it also refers to holographic images that can be impressed upon a metallized layer. Metallized holograms can also be de-metallized to give new haze readings for a whole host of other fraud resistant devices and novel commercially exploited consumer products.

The metal layers are laid down to give specific optical haze readings so that a predetermined designed amount of light is allowed to pass through the particles of metal under a variety of conditions and to prevent light transmission in other conditions, whereby in this instance, it reflects the light. In a further embodiment, a metallized layer can be created which will transmit a proportion of light incident from the rear so that back markings of the present invention can be revealed via manual or machine readable systems while reflecting light incident from the front such light prevents any back markings becoming visible.

In a particular preferred embodiment of the present invention, the sheet comprises further markings to the front of the metal layer. Such markings are visible to an observer, at all times, viewing the sheet from the front. Their utility will become clear below in connection with the particular embodiments of the present invention.

In a further preferred embodiment of the present invention, one or both of the sets of markings are sandwiched between the hologram and a plastic sheet, which is at least semi transparent. This makes tampering of markings even more difficult. It is particularly advantageous for the plastic layer to comprise inner and outer sub-layers, the outer layer having a higher melting point than the inner layers, such that by application of heat and pressure, during the laminating process, the plastic layer is fixed to the metallized/de-metallized layer. In such embodiments, it is particularly preferred that one or both such markings comprise a pigment or dye selected for its migrating properties upon heating. A sheet formed by this method is indelibly marked.

The sheet may itself be used to form an item, such as a credit card, which may be marked both against fraud and manufacturing quality control during the production phase.

In a still further embodiment of the present invention, the metallized transparent plastic can be coated to enable it to be printed by conventional means, being thin enough for use as a label and like devices.

It is preferred that the sheet according to the present invention be formed as a product label. Markings in front of the metallized sheet can be, for instance, advertising matter, manufacturer's name and the like; it is preferred that such a sheet will carry an attractive hologram so as to attract a potential purchaser's eye.

Most preferably, the sheet is for application to, or is applied to, at least a semi transparent product container. Market research shows that transparent packaging is the current packaging ploy. In this embodiment it is preferable that the container's contents prevents back lighting of the sheet, thereby preventing the observer from viewing the rearward markings until the container is partially or wholly emptied. For example, if the container is a bottle. These back markings, could, for instance, inform a purchaser whether or not he has won a competition.

To prevent viewing of the rearward markings prior to emptying of the container, light filters may be placed behind the said sheet. Alternatively, the label may extend around substantially, the entire circumference of the container, having a portion formed as a sheet or a coating according to the present invention whereby this coating or sheet is opaque, preventing incident back lighting thus preventing the viewer observing the back print by stealth, tilting or shining a light through the rear of the bottle. The best coating for this purpose is a lightly printed coating with a haze equal to the haze of the metallized sheet.

In accordance with a still preferred embodiment of this invention, the back markings plus other markings in front of the metallized layer or hologram overlap and as such transmit colored light, the coloring of the back markings being different from the coloring of the other markings, so that in the area where these two markings overlap, the color perceived by the observer changes according to the lighting conditions.

Specific embodiments of the present invention will now be described, by way of example.

Certain sheets constructed in accordance with this invention will firstly be described, followed by typical applications for this method.

The three layers of the sheet are, separated from one another, at a stage in the manufacturing process prior to assembly. They are subsequently passed through a laminator at a suitable temperature whereupon the polyethylene layers, are partly softened, and, due to the pressure exerted by the rollers, adhere to form a sheet which is difficult if not impossible subsequently to separate into its component layers. This is useful where the sheet is to be used for security or anti-fraud purposes, since it is not possible to tamper with the markings. It is particularly preferred that the printed markings are such as to permeate the polyethylene sub layers upon heating, thereby ensuring that these sub layers are permanently indelibly marked.

The polyester and polyethylene layers of the assembled sheet are transparent; the markings likewise can be transparent or opaque.

Where a hologram is used in a sub layer, it can comprise of a polypropylene or a polyester substrate, although other specific materials can be used, upon which de-metallized holograms and the like are laid.

Techniques for manufacture of a de-metallized hologram are well known. In one technique, substrates are coated with fine metal particles that are then embossed typically by means of a nickel plate, the profile for forming the hologram being formed on the face of the plate which is applied to the substrate/metal layer under pressure. De-metallizing of the resulting hologram in this particular process involves “washing” and rinsing the metal particles away. Where the actual impressions lie, the metal is harder to remove and thus remains leaving a clear area around the hologram.

For this reason, if a de-metallized hologram is used, it is preferred that the holograms in question are of a “compact” design such as a highly graphical image. It may for example be derived from photographic images. If there are large gaps in the image, the effectiveness of the present invention is impaired.

In the case of labels, however, it is preferred that the hologram or metallized layer/sheet is not of the de-metallized type, but has the metal particles laid down at a pre-determined thickness so as to produce the requisite designed haze.

It should be understood that the line of sight of an observer is referred to as the front face and the face remote therefore being referred to as the rear face.

When the sheet is front lit—the path of light rays impinging on the sheets' front surface whilst the back lighting of the sheet is prevented by a form of dark or semi-opaque background. Other suitable background descriptions will follow. Under such conditions the hologram/metal acts in a manner somewhat analogous of the action of a mirror—incident light is reflected. Consequently under these conditions an observer can see a holographic image or a metallized sheet and also the front markings, but the rearmost markings are hidden from view.

When the sheet is lit from the rear, light from that direction can pass through the metallized layer and consequently the observer sees both sets of markings.

A simplified sheet embodying the present invention can be manufactured with a reduced thickness It comprises a holographic or metallized layer, formed similarly to the hologram and or metallized sheet described above, bearing printed markings on both of its faces. Its function being similar to that already described.

In a further embodiment of the present invention, the perceived color of the markings on the sheet change according to the luminosity. In this particular example, the marking toward the front of the sheet consists, by way of example of the letters “WORDS” in yellow. The markings towards the rear of the sheet are in this case identical in shape and in its position in the sheet, but colored blue.

Both markings are such that their colors can be perceived when the markings are backlit (the markings not being wholly opaque). When the sheet is front lit, for reasons described above, incident light is reflected from the hologram/ metallized layer, only the front most markings affects the observed image, and the marking is perceived to be yellow. However, when back lighting is added, the observer also sees light that passes through the rear most markings. Consequently, the marking is perceived, as a result of the combination of yellow and blue, of the color spectrum to be green.

A change in the perceived color of the marking can thus be created by a change in the lighting of the sheet. It is to be understood that the yellow/blue color combination is referred to by way of example only, although research has found that not all color combinations are as effective.

It is not essential in such embodiments of the present invention that the front and rear-most markings are identical. For example, in a further embodiment, a rear-most blue marking could cover the entire sheet, so that under backlit conditions, the marking would be seen to be green against a blue background.

The sheets described above have various applications. However it is considered important applications are in the fields of marketing, advertising and security marking.

One such application, by way of example, can be applied to a bottle bearing a label extending all the way around the bottle's circumference. In this embodiment, the label's entire area is formed as a sheet in accordance with the present invention bearing a metal layer, which can also bear a hologram. This sheet may take any of the forms described above, although the simplified construction of a single film is preferred since it allows the label to be constructed to a thickness that will be equal to existing labels and thus allowing it to be used in existing labelling machines.

The bottle is substantially transparent and serves as a container for liquids, which is opaque, or, partially so, e.g. a cola based soft drink. While the bottle is full, the liquid thus serves as a dark background for the label, and consequently back lighting thereof is substantially prevented. Of the two sets of markings on the label, only the front-most is therefore seen by an observer, overlaid on the holographic image. When the bottle is emptied, light admitted through the bottle wall impinges on the rear of the label, making it possible additionally to see the rear-most markings and/or to perceive a color change in the markings, described above where the front and rear markings are of different colors.

Thus for example in a promotional scheme, the labels of selected bottles could bear innermost markings indicating that the purchaser had won a prize. It would not be possible to identify the prize-winning bottles until they had been emptied.

A difficulty could be encountered with some bottles of the type described in the previous paragraph, since it might be possible in practice to see the rear-most markings by holding the bottle up to an intense light source. Two methods have been devised to prevent this problem occurring.

In the case of the example described above, only a part of the label need be formed as a sheet. The remainder lies over a metal foil coating, which is wholly opaque. Consequently, light impinging upon the portion at the back of the bottle is prevented, which might otherwise have been viewed through the bottle's contents when back lighting the label.

In practice using this construction which when the bottle is emptied both sets of markings can be seen due, it is believed, to back-lighting of the label by virtue of light entering the bottle along directions non-perpendicular to the bottle axis. Because of light refraction and reflection due to the bottle being full the rear most markings cannot be seen even if intense light is shone at the rear of the bottle.

However, it has also been discovered that when intense light is shone on to the top of the liquid in the bottle, when the bottle is tilted, then the rays of light can bounce off the surface of the liquid and backlight the rear-most markings, making them visible at the front of the label. Experiments have proven that if a white background is printed over the entire rearmost markings at the rear of the label and that this white background is laid down in such a way that makes it partially opaque—then the light is reflected back off this white background and the rear-most markings cannot be seen. When the bottle is emptied the white background has no effect on the observers perception of the rearward markings. It has also been found, in some circumstances, that other colors used at the rear of the label can be used to the same effect, depending on the color of the contents or the color of the bottle. By way of example only, if the bottle is brown, the rearward color of the label can be brown also, instead of white.

It has also been found that if a number of printed films are laminated together, the color is enhanced. Also stereoscopic type images can be made by the fact that for example:—Mountains and sky can be printed on the first film, trees and bushes on the second etc and a foreground of, for example, a person, can then be printed on a third film. If a de-metallized, 3D hologram is inserted between each of the printed films, the resultant image appears to be 3D.

A further addition to the security aspect includes printing a document so small, that it cannot be read by the naked eye, but can be read with the use of a magnifying glass or alternatively a machine designed to read such print.

A still further embodiment enables security to be enhanced by applying a prism effect.

Where plastic incorporates a number of prisms—some running in one direction whilst others run in another. To read a document, a correcting card is required or the card can be tilted to a certain angle to enable it to be read.

In another embodiment, security can be enhanced by the addition of a foil, preferably metal, which has been embossed with lettering or design. This foil is encapsulated between the sheets of plastics material. Also, this foil can be encapsulated in a plain state so that for example, with credit cards, if the card is stamped with round letters and/or numbers these can be easily read by the naked eye.

If an electrically conductive ink/dye/paint within the card, is used, the card can be used as part of an electrical circuit or a switch to cause a short circuit to, say, light up a bulb or open a door (i.e. as a key card).

Another embodiment of the invention is to print either part or the entire document with white ink/dye etc. thus preventing photocopying, as few photocopiers have the optical capabilities to read or print in white.

Other ways of printing in white are to cut out shapes/letters/numbers etc. from the paper that has a high loading of silica then to transfer this silica to the laminate, the means previously described in this invention, during final lamination, the white print will remain. This same effect can be made by using high loadings of silica, laid down as letters or graphics, directly onto paper, which in turn can be already a silica paper, and this resultant sheet offered up to the plastics sheet as previously described in this invention.

A design using alpha numeric codes placed on the coating or rather on the coating of the paper at the time of manufacture, i.e. the first thin coating is applied, then, when dry, a second coating is applied using rollers that will leave the design required proud of the first coating. This second coating will have to be thick enough to give a total thickness required for the specification.

A colored design, printed around the resulting white design can then be used with the intention of allowing the color to bleed into the design within a given period.

Experiments have proved that the “opticmark” cannot be photocopied either.

It has also been discovered that if two layers of plastic are printed with the same details, but adhered/welded together with a de-metallized hologram between the two prints each of which is slightly off-set, then a blurred print results, but if the card is tilted to one side, the prints optically line up and can be easily read. Also, if a dark background or even one's hand is placed behind the document, the same effect can be achieved.

A further embodiment is that two identical, black prints can be made and laminated offset so that the print can be in a small portion of the card/document or covers the entire card/document; when viewed straight on, the whole print appears as either a black portion or an entirely black card until the card is viewed at an angle or placed against a dark background or even one's hand.

A further embodiment, is the use of a passive tag within the document, this could be triggered from any distance, including outer space by using electromagnetic waves. When triggered this could be used to start the bleed process off, by allowing the flow of moisture to enter the print area, due to either rupture the coil or trigger other devices such as Giant Magneto-strictive (GMM) materials which in their turn will either expand or contract acting like a shut off valve will ensure fluid flow to take place; the flow of fluid or atmospheric moisture, penetrating the colorant and thereby setting in motion the bleed process.

In a further embodiment, it has been found that all products can have aids for the blind, such as Braille and Moon, these aids can be incorporated in a number of ways but it has been found that markings can be applied that remain within the plastic and can be understood by the blind. These markings can be made in various ways and by way of examples only, it has been found that if Moon or Braille are etched onto a plate and the finished document is passed over this plate under pressure, marks can be made that will remain with the plastic. These raised areas must be at least 100 microns in height with a preferred height of 150 microns. The blind find markings below 100 microns difficult to read. The same result can be achieved through print, using a printing machine that will lay ink down in thicknesses greater than 100 microns such as in silkscreen printing methods or machines that lay down wax.

1. A method of printing on plastic and like materials and their construction to produce anti-counterfeit or difficult to copy print together with a label that shows the passing of time by use of a bleed process within the label produced on or within two or more layers of plastics; said layers having holograms and other items like watermarks within being laminated together by various methods which can withstand creasing, moulding and fabrication without degradation of the print which does not come into contact with any other products protected by the process.

2. A process for printing plastic films comprising placing colorants onto layers of particulate or colloidal materials, which materials are releasably bound to a backing; comprising transferring the colorant onto a plastic film by placing the film over a printed layer applying a substantially constant heat, removing the backing characterised in that the particulate or colloidal materials has a specific particle size which gives either opaque or transparent final product, depending on the size of the particles.

3. A process according to claim 2 wherein the particle size is large enough not to breakdown when heated, thus giving an opaque print.

4. A process according to claim 2 wherein the particle size is small enough to break down when heated to give a transparent print.

5. A process according to claim 2 wherein the particulate or colloidal materials contains silica and the like which material is used as a conveyance of print to a plastic medium.

6. A process according to claim 2 wherein the particulate or colloidal materials contains silica and the like and is mixed with a colorant before being laid down in a dry or wet state onto a plastic sheet using a printing machine.

7. A process according to claim 2 wherein the backing is parchment paper, produced by dipping paper in concentrated sulphuric acid.

8. A process according to claim 2 wherein at least one layer comprises specific particulate and/or colloidal material or mixtures thereof for creating various degrees of opaqueness through to transparent print.

9. A process for producing a document having a colorant which does not bleed, comprising printing the colorant onto a layer of particulate or colloidal material, which layer is releasably bound to a backing; transferring the colorant onto a plastic film, placing the plastic film over a printed layer and subjecting the film and printed layer to a specified constant heat, removing the backing; and laminating a second plastic film to the first film at a temperature specific to the process being undertaken.

10. A process, according to claim 9 wherein a metalised or de-metalised hologram which is transparent or partly transparent is sandwiched between two transparent printed plastic sheets, said hologram covering the entire area of the document.

11. A process according to claim 10 wherein the metalised or de-metalised hologram has a specific optical haze/density which will allow light to transmit through the entire document but will reflect light when the document is placed in front of something that will impede light from the rear.

12. A process for producing a document having a colorant which bleeds after a period of time comprising printing the colorant onto a layer of particulate or colloidal material, which layer is releasably bound to a backing; transferring the colorant onto a plastic film, placing the plastic film over a printed layer, subjecting the film and printed layer to a specified constant heat, removing the backing; and subjecting the film to a specific humidity for a certain length of time before laminating a second plastic film to the first film at a temperature specific to the bonding process being undertaken.

13. A process to achieve colorant bleeding comprising placing silica on a plastic film; printing colorant onto the silica; covering the printed silica by a second plastic film which has an opening within it which lies over the printed silica at a specific point, placing above this opening, a reservoir of fluid which can be in an encapsulated form or held within a medium such as absorbent paper or in a solid state such as ice or paraffin wax and the like, positioning a barrier between the opening and reservoir of fluid which when broken allows the fluid to pass through the opening and be absorbed by the silica.

14. A process according to claim 13, wherein the flow of fluid along the path of the printed silica can show the passage of time.

15. A process according to claim 13 wherein the fluid is or contains a solvent which dissolves the printed colorant and carries it along with itself making it easier to see and thus determine speed and or the passage of time.

16. A process according to claim 13 wherein an ultraviolet sensitive or reflective material is either inserted between the first and second plastic film or is adhered to the surface of the finished product to help protect the colorant from the effects of ultraviolet or other light forms.

17. A process according to claim 13 wherein the document comprises at least one region of weakness whereby the document can be manually torn to expose the silica to the atmosphere allowing absorption of moisture from the atmosphere to facilitate a bleed reaction within the colorant.

18. A process according to claim 13 wherein the passage of time, shown by the migration of colorant, can be altered by varying the amount of silica laid down onto a plastic sheet.

19. A process according to claim 13 wherein printed silica is laid down on a single plastics sheet so that it is always in contact with the atmosphere and thus will attract moisture from the atmosphere and show a reaction through the migration of ink within that printed area.

20. A process according to claim 19 wherein the silica laid down on the plastic sheet is not printed on but has a print on the other side of the plastic sheet; the silica being laid down thickly enough to stop the print being seen from the side the silica is placed; but thin enough so that when the silica becomes wet and thus somewhat transparent, the print on the rearward side can be seen.

21. A process comprising a printed silica label attached to clothing, an opening formed in said label that will allow body moisture to enter and be absorbed and said label showing how long the garment has been worn by the fact that most if not all the label will have bled if worn for more than a specific time.

22. A label as claimed in claim 11 or 21 having a holographic image on its rearward side and which in turn is adhered to an item in such away that if the label is removed the hologram is destroyed by the fact that it's layers are pulled apart.

23. A process according to claim 5 or 13 wherein a printed silica document, designed to show the passing of time, uses liquids of various viscosities to determine the speed of bleeding; the higher the viscosity, the slower the speed of reaction.

24. A process according claim 23 wherein the liquid comes into contact with the silica through a predetermined sized aperture.

25. A process according to claim 23 wherein the liquid is contained within a material that will work like a wick, such as paper, thus enabling the liquid to be held in a usable form.

26. A process according to claim 25 wherein the liquid is held in an encapsulated form whereby pressure is needed to be exerted to release the liquid, enabling contact to be made with the silica.

27. A process according claim 23 wherein the dry printed silica and the wetting agent are manufactured separately and are later united together to start the bleed reaction to show the passage of time.

28. A process according claim 21 wherein a label is designed with a dried silica on one side and a wetting agent on the other and the label is folded over to bring the two parts together and start the desired reaction.

29. A process according to claim 28 wherein one or both sides of the label have an aperture that must be mated together to start the reaction.

30. A process according to claim 28 wherein the label is divided into compartments using adhesive or other bonding materials to keep each part separated from outside influences such as humidity or other contaminates.

31. A process according to claim 30 whereby one of the compartments contains a reservoir for a liquid which can be held within that compartment in a form consisting of loose liquid, ice, paraffin wax, silica gel, glass beads, micro-encapsulation, absorbent paper which when required by the user, can be allowed to leach out into a second compartment which contains a dried silica.

32. A process according to claim 31 wherein said one of the compartments contains a liquid which can be allowed to leach out into a second compartment that contains no silica but has just a printed ink which will react with the liquid causing a color change over a period of time.

33. A process for creating colorant bleed comprising using giant magneto-strictive material (GMM) and produced from rare earth elements; terbium, samarium and dysprosium, said GMM being placed in a channel between a encapsulated colorant reservoir and the delivery canal; which, depending on requirements, acts as a shut off valve by contraction or expansion, or can, when activated, fracture the plastic, allowing bleed into the colorant delivery conduit, when subjected to electromagnetic energy.

34. A method of producing a metalised label wherein the specific density of metalisation reflects light when there is no back lighting to obscure print on the rearward side of the label but allows the print to be seen on the rearward side when light is allowed to pass through the rear of the label.

35. A method according to claim 34 wherein a second colorant is printed over the print on the rearward side of the label which impedes incidental light from revealing the first rearward print.

36. A process comprising two prints, which are similar to each other, printed onto both sides of a transparent document, said transparent document printed on both sides when looked at through a light background appearing to have the print offset to each other, causing difficulty in reading the print until a dark background is placed behind said print.

37. A process according to claim 36 wherein white print is used within a transparent document making it difficult to reproduce.

38. A process of applying a time sensitive label to a carton comprising punching a hole at a specific point in the carton, placing a wick in the hole and placing a label over the wick that shows the passing of time.

39. A process according to claim 38 whereby, after the carton is constructed and filled with a liquid, the liquid in the carton acts upon the printed silica placed on the label to show the passing of time since the carton was filled.

40. A process according to claim 38 wherein said label that shows the passing of time is adhered to a container so that when said container is opened the label is torn or pulled apart at a specific point and starts a reaction.

41. A process according to claim 39 wherein the liquid is a bleaching agent that turns the print either white or clear and can thus show up markings on the rear of the label.

42. A puzzle constructed in accordance with claim 2 which shows only a white color and when all the pieces have been placed in their correct positions the reaction starts or can be started that will then reveal the picture.

43. A process as claimed in claim 38 wherein said label shows the passing of time, as each determined point is reached, and liquid reacts with a chemical placed at that point causing a reaction that causes the label to rise at that point so that it can be felt by a person with vision impairment.

44. A process according to claim 36 whereby within the transparent document is placed a fingerprint or bio-metric image that can be placed over a stored image to verify authenticity.

45. A process according to claim 21 wherein an alarm system is activated by fluid travelling past a given point in the label causing the shorting of an electrical current.

46. A process according to claim 21 wherein the label has a specific optical haze enabling print to be placed on both sides of the label, but obstructing the print on the rearward side until light is placed behind it.

47. A process according to claim 9 wherein etched florescent fibre optics are placed within the laminated document so that when subjected to light, an etching can be viewed.
